(19) United States
(12) Patent Application Publication
(10) Pub. No.: US 2007/0019677 A1
(43) Pub. Date: Jan. 25, 2007

(54) Data processing method and system based on a serial transmission interface

(75) Inventors: Chih-Chiang Wang, Taipei (TW); Chao-Ming Sung, Taipei (TW); Tian-Jie Kuo, Taipei (TW); Yuh-Dar Tseng, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/358,875

(22) Filed: Feb. 21, 2006

(30) Foreign Application Priority Data
Jul. 21, 2005 (TW) 94124682

(51) Int. Cl. H04J 3/16

(52) U.S. Cl. 370/469

(57) ABSTRACT

A data processing method based on a serial transmission interface applied to PCI Express data transmission. A data packet is received by a physical layer. The data packet is transmitted to a data link layer and a transaction layer simultaneously. The data packet is processed by the data link layer and the transaction layer simultaneously.

### BACKGROUND OF THE INVENTION

1. Field of the Invention

The invention relates to a data processing method, and in particular relates to a data processing method based on a serial transmission interface.

2. Description of the Related Art

A bus is an interface between hardware components for data transmission. Wider bus bandwidth in a computer device is required when transmitted data (bit) increases or the speed of data transmission is higher, enabling higher processing speed of a computer system. Bus types comprise Industrial Standard Architectural (ISA) bus, Protocol Control Information (PCI) bus, Third Generation Input/Output Architecture (3GIO) bus, and others. A 3GIO bus is also referred to as a PCI Express bus.

PCI Express is a peer-to-peer serial transmission technology. PCI Express employs a multi-layer architecture, comprising a physical layer (the first layer), data link layer (the second layer), and transaction layer (the third layer). The physical layer comprises two independent lanes having a transmitter and receiver. The data link layer ensures security and reliability of data packet switching and is capable of flow control. The transaction layer retrieves read/write requests from an upper layer and requests the data link layer to transmit data packets.

As described, the physical layer for the PCI Express bus comprises two independent lanes, one of which acts as a transmitter and the other acts as a receiver. The PCI Express bus, not a shared architecture, transmits data packets using the two lanes, such that data transmission interference can be overcome and each data packet has the first priority for data processing. As a result, data transmission speed for the PCI Express bus is much faster than that of the PCI bus.

FIG. 1 is a schematic view of layered protocol architecture of a receiver for PCI Express transmission. The PCI Express architecture for receiver (Rx) 100 comprises a physical layer 110, a data link layer 120, a transaction layer 130, and a software application 140. A transmitter (Tx) (not shown) packages data as a plurality of data packets, implements frame relay using fast packet technology, and attaches header or packet information of each layer to each data packet in the sequence of the transaction layer, data link layer, and physical layer.

Referring to FIGS. 2A and 2B, FIG. 2A is a flowchart of data packet transmission of transmitter 200a for a PCI Express bus, and FIG. 2B is a flowchart of data packet transmission of receiver 200b for the PCI Express bus. Referring to FIG. 2A, transmitted data is packeted as a plurality of data packets and each data packet is transmitted through software layer 140a. Next, header 220a is attached to a data packet comprising desired data 210a transmitted to transaction layer 130a. Header 220a records source and destination addresses of the data packet, ensuring that data 210a of the data packet reaches transaction layer 130b of receiver 200b. Next, the data packet is transmitted to data link layer 120a and sequence number 230a and link cyclical redundancy check (LCRC) 240a are attached thereto. Sequence number 230a represents the order of the current transmitted data packet among the data packets and is referred by software layer 140b of receiver 300 for data packet recombination. LCRC 240a ensures data 210a is correct and complete of. Next, the data packet is transmitted to physical layer 110a and frame type 250a is attached thereto. Frame type 250a represents the data type of data 210a.

Referring to FIG. 2B, when the data packet has been processed, the data packet is transmitted to receiver 300 through a transmission media for unpacketing attached information. The data packet is transmitted to physical layer 110b, frame type 250b relating to the data packet comprising data 210b is retrieved and software layer 140b can thus recognize the data type of data 210b. Next, the data packet is transmitted to data link layer 120b, sequence number 230b and LCRC 240b of the data packet is retrieved, and software layer 140b can thus recognize the transmission order of the data packet and verifies that data 210b is correct and complete. Next, the data packet is transmitted to transaction layer 130b, header 220b of the data packet is retrieved, and software layer 140b can thus recognize address information of the data packet. When the unpacketing process is complete, data 210b is transmitted to software layer 140b for repacketing.

With respect to the PCI Express architecture, data packets must be packeted and unpacketed layer by layer, in the order of the transaction layer, data link layer, and physical layer. The described data processing method, however, results in poor efficiency for large amounts of data, thus an improved data processing method is desirable.

### BRIEF SUMMARY OF INVENTION

A data processing method based on a serial transmission interface applied to PCI Express data transmission. A data packet is received by a physical layer. The data packet is transmitted to a data link layer and a transaction layer simultaneously. The data packet is processed by the data link layer and the transaction layer simultaneously.

The method further comprises determining whether an error is detected when the transaction layer processes the data packet, sending a message from the transaction layer to the physical layer for re-transmission if any one error is detected, and forcing the physical layer to transmit the data packet to the transaction layer.

The method further comprises determining whether an error is detected when the data link layer processes the data packet, the transaction layer retrieving data packeted in a last data packet from the data buffer, the transaction layer sending the message for re-transmission to the physical layer, and forcing the physical layer to transmitting the data packet to the data link layer and transaction layer simultaneously.

A data processing system based on a serial transmission interface is provided. The system is applied to a receiver for PCI Express data transmission, comprising a physical layer, a data link layer, and a transaction layer. The physical layer receives a data packet, from a transmitter, and then transmitting out. The data link layer receives the data packet from the physical layer. The transaction layer receives the data packet from the physical layer. The data packet is processed by the transaction layer and the data link layer simultaneously. The system further comprises data buffer for storing data packeted in the data packet.

With respect to the system, the transaction layer determines whether an error is detected when the data packet is processed, and, if so, sending a message for re-transmission to the physical layer. The physical layer re-transmits the data packet to the transaction layer, and the transaction layer stores data packeted in the data packet in the data buffer if no error is detected. The data link layer determines whether an error is detected when the data packet is processed, and, if so, the transaction layer retrieves the data packeted in the last data packet from the data buffer and sends a message for re-transmitting to the physical layer, and the physical layer is forced to transmits the data packet to the data link layer and the transaction layer simultaneously. The data link layer sends a success message to the transaction layer if no error is detected.

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIG. 1 is a schematic view of layered protocol architecture of a receiver for PCI Express transmission;

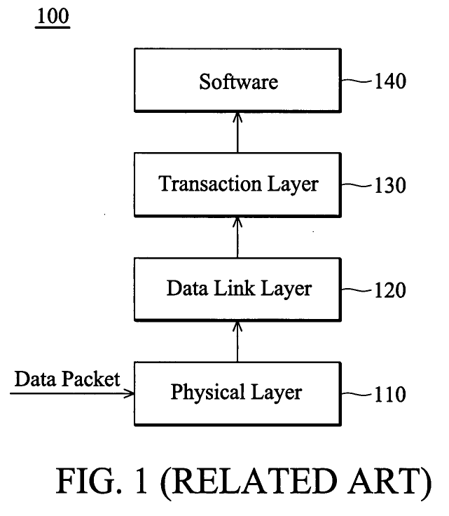

FIG. 2A is a flowchart of data packet transmission of transmitter 200a for a PCI Express bus;

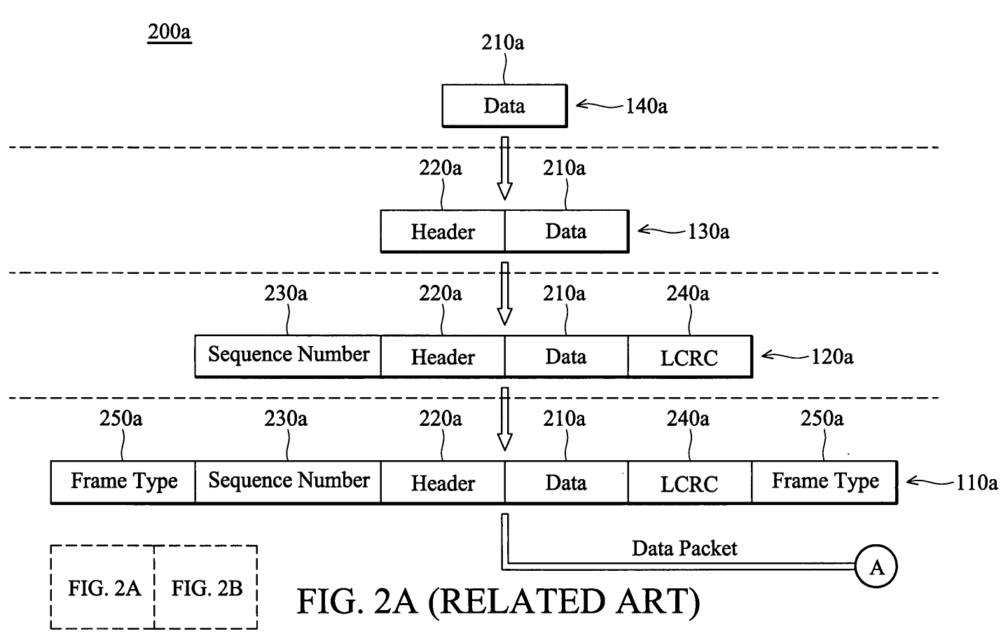

FIG. 2B is a flowchart of data packet transmission of receiver 200b for the PCI Express bus;

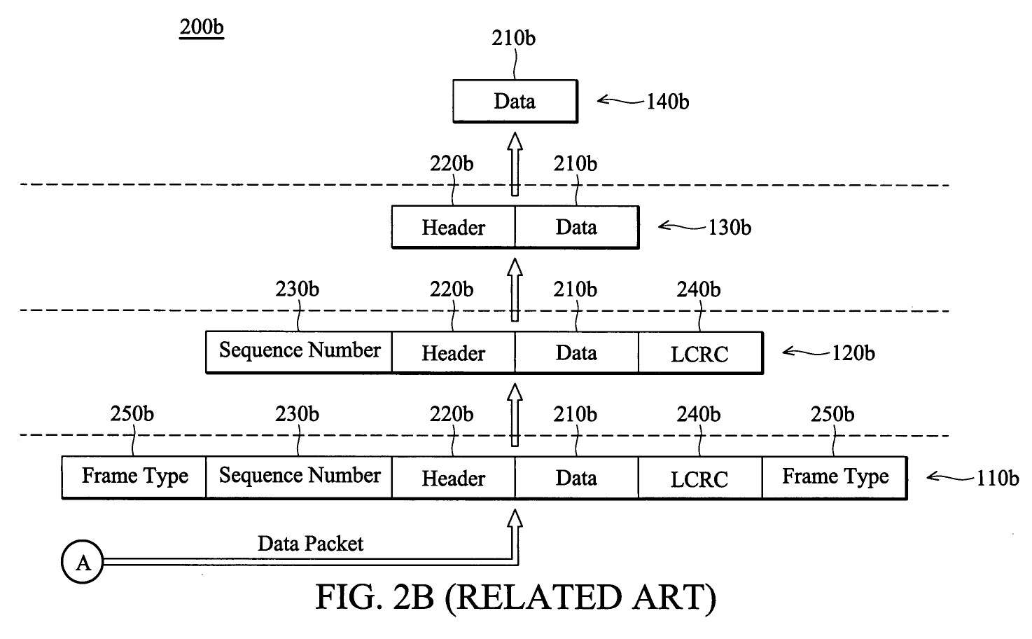

FIG. 3 is a schematic view of an embodiment of the architecture of receiver 300 for PCI Express transmission;

FIG. 4 is a flowchart of an embodiment of data packet transmission for PCI Express; and

FIG. 5 is a flowchart of an embodiment of a data processing method based on a serial transmission interface.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a data processing method and system based on a serial transmission interface.

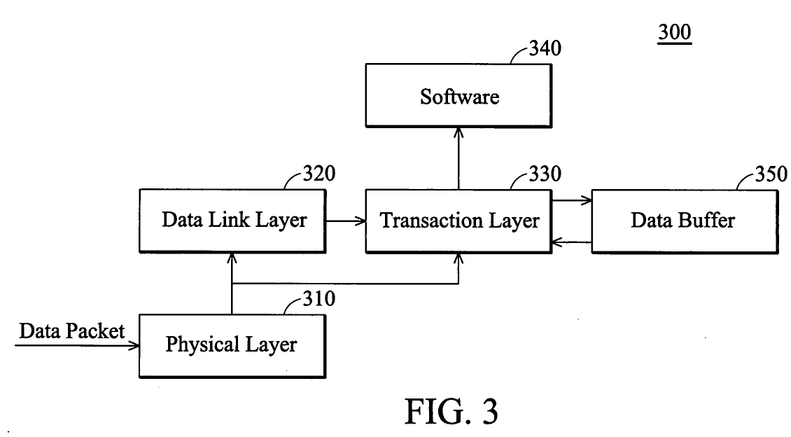

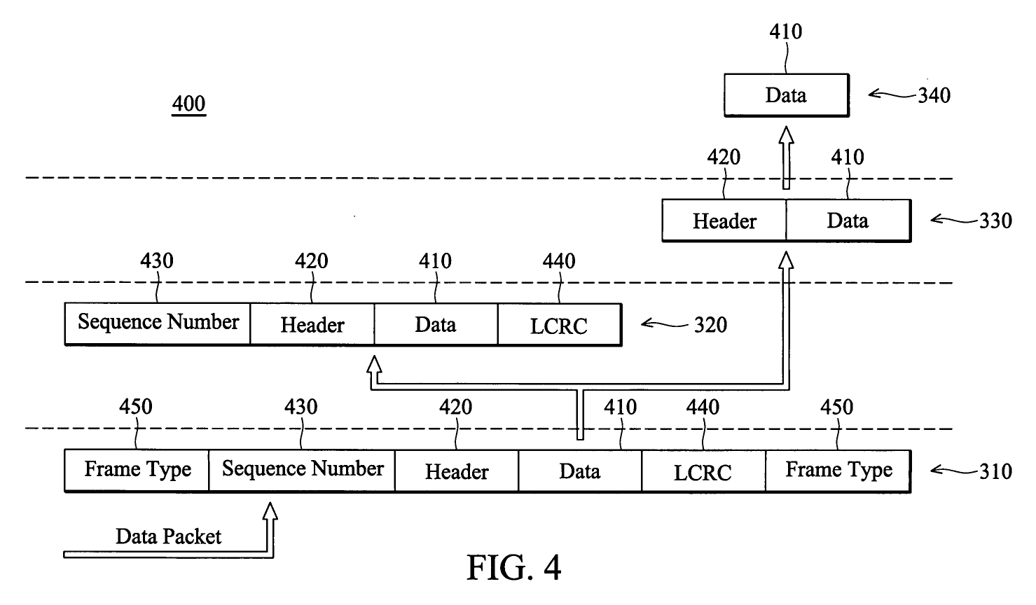

Referring to FIGS. 3 and 4, FIG. 3 is a schematic view of an embodiment of the architecture of receiver 300 for PCI Express transmission and FIG. 4 is a flowchart of an embodiment of data packet transmission for PCI Express. Receiver 300 of the architecture comprises physical layer 310, data link layer 320, transaction layer 330, software layer 340, and data buffer 350. A transmitter (not shown) packets data as a plurality of data packets and transmits the data packets to receiver 300 by implementing frame relay using fast packet technology, in the order of the transaction layer 330, data link layer 320, and physical layer 310, in which the header or packet information for each layer is attached to each data packet sequentially. As described, data is packeted as a plurality of data packets and the data packets are transmitted in sequence by a transmitter (not shown) through a software layer (not shown). A data packet comprising data 410 is transmitted to a transaction layer (not shown) and header 420a is attached thereto. Next, the data packet is transmitted to a data link layer (not shown) and sequence number 430a and LCRC 440a are attached thereto. Next, the data packet is transmitted to a physical link layer (not shown) and frame type 450a is attached thereto. The data packet is then transmitted to receiver 400 via a transmission media (not shown).

Referring to FIG. 4, receiver 400 receives, from the transmitter (not shown) via a transmission media 460, and unpackets a data packet. Physical layer 310 first receives the data packet comprising data 410 from the transmitter, frame type 450 of the data packet is retrieved, and software layer 340 can thus recognize the data type of data 410. The data packet is then transmitted to data link layer 320 and transaction layer 330 simultaneously.

The feature of the invention is to transmit data packets from physical layer 310 to data link layer 320 and transaction layer 330 simultaneously for synchronous data processing. Data link layer 320 retrieves the data packet from physical layer 310 and obtains sequence number 430 and LCRC 440 thereof, and software layer 340 can thus recognize the transmitting order of the data packet and verify that data 410 is correct and complete. When the data process is complete, data link layer 320 sends a success message to transaction layer 330, but sends a failure message to transaction layer 330 if an error is detected during the data process. When the data packet is successfully processed, data link layer 320 also transmits the processed data packet to transaction layer 330, such that transaction layer 330 can recognize whether an error is detected during data processing.

Furthermore, transaction layer 330 receives the data packet from physical layer 310 and retrieves header 420 thereof, and software layer 340 can thus recognize source and destination addresses of the data packet and stores duplicated data 410 in data buffer 350. When the data packet is successfully processed, if no error is detected during the data process, transaction layer 330 transmits data 410 of the data packet to software layer 340 for repacketing. When an error is detected during the data processing, transaction layer 330 abandons the data packet and sends a message for re-transmission to physical layer 310, and physical layer 310 then re-transmits the data packet to transaction layer 330 (rather than both of the two layers). Furthermore, when the re-transmitted data packet is successfully processed, transaction layer 330 stores duplicated data of the data packet in data buffer 350 to replace the previously stored data.

As described above, data link layer 320 sends a success or failure message to transaction layer 330 according to processing results. When a failure message is received from data link layer 320, transaction layer 330 abandons the current data packet, retrieves the data packeted in a last data packet from data buffer 350 for state maintenance of data transmission, and sends a message for re-transmiission to physical layer 310. When the message for re-transmission is received, physical layer 310 re-transmits the data packet to data link layer 320 and transaction layer 330 simultaneously for further data processing.

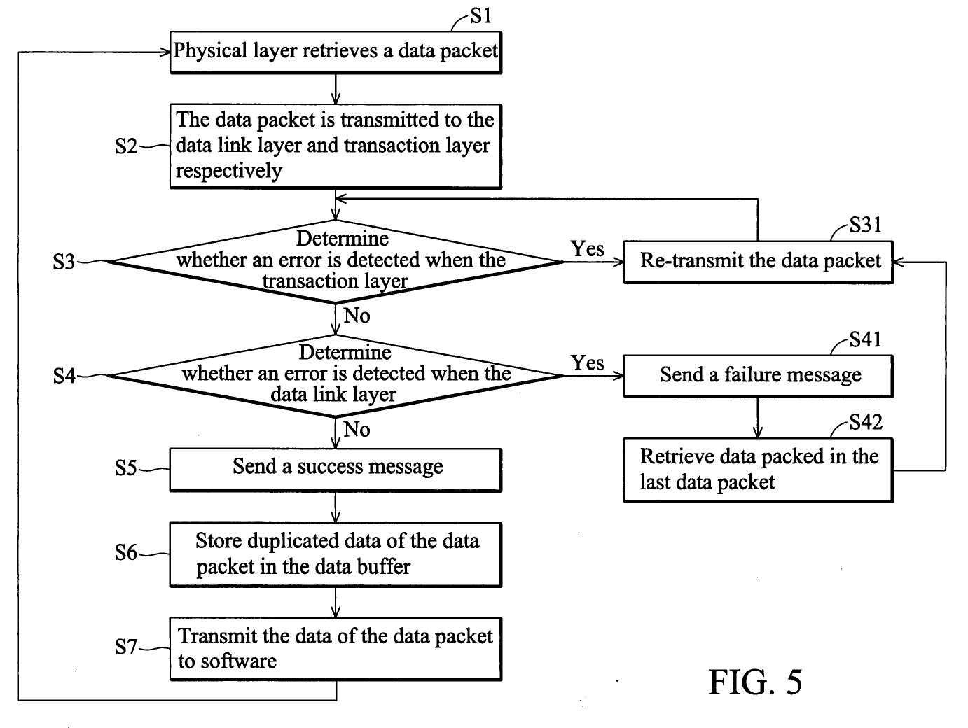

FIG. 5 is a flowchart of an embodiment of a data processing method based on a serial transmission interface.

A physical layer, a data link layer, a transaction layer, and a data buffer storing data packeted in a last data packet are first provided. The physical layer retrieves and processes a data packet from a transmitter (step S1) and the processed data packet is transmitted to the data link layer and transaction layer simultaneously (step S2). Next, it is determined whether an error is detected when the transaction layer processes the data packet (step S3), and, if so, the process proceeds to step S31, and, if not, to step S4.

Next, if an error is detected when the transaction layer processes the data packet, the transaction layer abandons the data packet and sends a message for re-transmission to the physical layer. When the message for re-transmission is received, the physical layer re-transmits the data packet to the transaction layer (step S31), and the process proceeds to step S3. If no error is detected when the transaction layer processes the data packet, it is then determined whether an error is detected when the data link layer processes the data packet (step S4), and, if so, the process proceeds to step S41, and, if not, to step S5.

If an error is detected when the data link layer processes the data packet, the data link layer sends a failure message to the transaction layer (step S41). When the failure message is received, the transaction layer abandons the current data packet, sends a message for re-transmission to the physical layer, and retrieves the data packeted in a last data packet from the data buffer for state maintenance of data transmission (step S42). The process then proceeds to step S31, the physical layer re-transmits the data packet to the data link and transaction layers simultaneously (step S31).

If no error is detected when the data link layer processes the data packet, the data link layer sends a success message to the transaction layer (step S5). When the success message is received, the transaction layer stores duplicated data of the data packet in the data buffer (step S6) and transmits the data in the data packet to a software layer (step S7). The physical layer repeatedly retrieves another data packet from the transmitter for data processing until all the data packets are retrieved.

A data processing method of the invention enhances data processing efficiency, reduces data processing time, and provides a data buffer to manage error occurrence during data packet transmission.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data processing method based on a serial transmission interface, applied to PCI Express data transmission, comprising:
receiving a data packet by a physical layer;
transmitting the data packet to a data link layer and a transaction layer simultaneously; and
processing the data packet by the data link layer and the transaction layer simultaneously.

2. The data processing method as claimed in claim 1, the step of processing the data packet further comprising:
determining whether an error is detected when the transaction layer processes the data packet;
sending a message from the transaction layer to the physical layer for re-transmission if any one error is detected; and
forcing the physical layer to transmit the data packet to the transaction layer.

3. The data processing method as claimed in claim 2, wherein the transaction layer stores data packeted in the data packet in a data buffer if no error is detected.

4. The data processing method as claimed in claim 3, the step of processing the data packet further comprising:
determining whether an error is detected when the data link layer processes the data packet;
the transaction layer retrieving data packeted in a last data packet from the data buffer;
the transaction layer sending the message for re-transmission to the physical layer; and
forcing the physical layer to transmitting the data packet to the data link layer and transaction layer simultaneously.

5. The data processing method as claimed in claim 4, further comprising:
sending a success message to the transaction layer if no error is detected of the data link layer.

6. A data processing system based on a serial transmission interface, applied to a receiver for PCI Express data transmission, comprising:
a physical layer, capable of receiving a data packet, from a transmitter, and then transmitting out;
a data link layer, capable of receiving the data packet from the physical layer; and
a transaction layer, capable of receiving the data packet from the physical layer,
wherein the data packet is processed by the transaction layer and the data link layer simultaneously.

7. The data processing system as claimed in claim 6, further comprising a data buffer for storing data packeted in the data packet.

8. The data processing system as claimed in claim 7, wherein the transaction layer determines whether an error is detected when the data packet is processed, and, if so, sending a message for re-transmission to the physical layer.

9. The data processing system as claimed in claim 8, wherein the physical layer re-transmits the data packet to the transaction layer, and the transaction layer stores data packeted in the data packet in the data buffer if no error is detected.

10. The data processing system as claimed in claim 9, wherein the data link layer determines whether an error is detected when the data packet is processed, and, if so, the transaction layer retrieves the data packeted in the last data packet from the data buffer and sends a message for re-transmitting to the physical layer, and the physical layer is forced to transmits the data packet to the data link layer and the transaction layer simultaneously.

11. The data processing system as claimed in claim 10, wherein the data link layer sends a success message to the transaction layer if no error is detected.

12. A data processing method based on a serial transmission interface, applied to PCI Express data transmission, comprising:
providing a physical layer, a data link layer, a transaction layer, and a data buffer, and the data buffer stores data packeted in a first data packet received from the physical layer;
receiving and transmitting a second data packet from the physical layer to the data link layer and the transaction layer simultaneously;
processing the data packet by the data link layer and the transaction layer simultaneously;
determining by the transaction layer whether an error is detected when the second data packet is processed; and
forcing the physical layer to transmitting the second data packet to the data link layer and the transaction layer simultaneously and retrieve the data packed in the first data packet from the data buffer if a error is detected.

13. The data processing method as claimed in claim 12, wherein error determination for the transaction layer further comprises:
the transaction layer sending a message for re-transmission to the physical layer if any one error is detected; and
forcing the physical layer re-transmitting the second data packet to the transaction layer.

14. The data processing method as claimed in claim 13, if no error is detected, further comprising:
storing the data packeted in the second data packet in the data buffer to replace the data packeted in the first data packet by the transaction layer.

15. The data processing method as claimed in claim 12, the step of data processing for the data link layer further comprising:
determining whether an error is detected when the second data packet is processed;
sending a failure message from the data link layer to the transaction layer if an error is detected;
retrieving the data packeted in the first data packet from the data buffer and sending a message for re-transmission to the physical layer by the transaction layer;
re-transmitting the second data packet from the physical layer to the data link layer and the transaction layer simultaneously.

16. The data processing method as claimed in claim 15, the step of data processing for the data link layer further comprising:
sending a success message to the transaction layer if no error is detected.
